(19) United States
(12) Patent Application Publication
(10) Pub. No.: US 2019/0123522 A1
(43) Pub. Date: Apr. 25, 2019

(54) ELECTRICAL UNIT

(71) Applicant: Lear Corporation, Southfield, MI (US)

(72) Inventors: Christopher J. Darr, Livonia, MI (US); Peter Kowtun, Plymouth, MI (US); Bruce H. Pierik, Hazel Park, MI (US)

(21) Appl. No.: 16/165,142

(22) Filed: Oct. 19, 2018

Related U.S. Application Data
(63) Continuation-in-part of application No. 15/790,953, filed on Oct. 23, 2017.

(51) Int. Cl. H02B 1/20; H01H 85/20; H02B 1/18; H02B 1/48

(52) U.S. Cl. CPC H02B 1/20; H01H 85/205; H01H 85/2045; H01H 85/20; H01H 2085/0275; H02B 1/48; H01H 2085/206; H01H 2085/209; H01H 2085/208; H02B 1/18

(57) ABSTRACT

An electrical unit includes a first housing member, a second housing member, and a fuse assembly. The fuse assembly may include a pre-fuse bus bar disposed at least partially in the first housing member. The first housing member may be configured to receive a first electrical connector. A plane may extend through the pre-fuse bus bar and the first electrical connector. The fuse assembly may include a fuse, and the plane may extend through the pre-fuse bus bar, the first electrical connector, and/or the fuse. The first housing member may be configured to receive a second electrical connector.

### CROSS-REFERENCE TO RELATED APPLICATION

This application is a continuation-in-part of and claims the benefit of U.S. patent application Ser. No. 15/790,953, filed on Oct. 23, 2017, the disclosure of which is hereby incorporated herein by reference in its entirety.

### TECHNICAL FIELD

The present disclosure generally relates to electrical units, including electrical units, junction boxes, and power distribution boxes that may be used in connection with vehicles.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some electrical units may be utilized in connection with separate pre-fuse assemblies that may require additional cables and/or wiring harnesses. Some electrical units may be configured for external connections with wiring harnesses.

There is a desire for solutions/options that minimize or eliminate one or more challenges or shortcomings of electrical units. The foregoing discussion is intended only to illustrate examples of the present field and should not be taken as a disavowal of scope.

### SUMMARY

In embodiments, an electrical unit may include a first housing member, a second housing member, and/or a fuse assembly. The fuse assembly may include a pre-fuse bus bar disposed at least partially in the first housing member. The first housing member may be configured to receive a first electrical connector such that a plane may extend through the pre-fuse bus bar and said first electrical connector. The fuse assembly may include a fuse, and the plane may extend through the pre-fuse bus bar, the first electrical connector, and/or the fuse. The first housing member may be configured to receive a second electrical connector such that said first electrical connector may be disposed between the pre-fuse bus bar and said second electrical connector. The first housing member may be configured such that the plane may extend through the pre-fuse bus bar, said first electrical connector, and/or said second electrical connector. The pre-fuse bus bar may be disposed substantially to a side of the first housing member. A circuit board bus bar may be connected to the pre-fuse bus bar. The circuit board bus bar may be at least partially disposed in the second housing member and may be connected directly to a circuit board of the second housing member.

With embodiments, an electrical assembly may include an electrical unit, a first electrical connector, and a second electrical connector. A pre-fuse bus bar may be laterally offset from at least one of the first electrical connector and the second electrical connector. The pre-fuse bus bar may be aligned substantially between a first longitudinal end of said first electrical connector and a second longitudinal end of said first electrical connector (e.g., may be offset in an X-direction and may be aligned in a Y-direction). The pre-fuse bus bar may be aligned substantially between a first longitudinal end of said second electrical connector and a second longitudinal end of said second electrical connector. A first electrical connector and/or a second electrical connector may include at least 10 terminals, at least 15 terminals, at least 20 terminals, at least about 50 terminals, and/or more or fewer terminals.

In embodiments, an electrical assembly may include an electrical unit, a first wire, and a second wire. The first wire and the second wire may be connected to a pre-fuse bus bar. A current capacity of the first wire may be greater than a current capacity of the second wire. The pre-fuse bus bar may include a first portion, a second portion, a third portion, and/or a fourth portion. The first portion may be disposed substantially perpendicular to the second portion. The third portion may be substantially perpendicular to the fourth portion. The third portion and the fourth portion may be perpendicular to the first portion. The first portion and the second portion may be substantially horizontal. The third portion and the fourth portion may be substantially vertical. A plane may extend through the third portion and the fourth portion of the pre-fuse bus bar. The first portion, the second portion, the third portion, and/or the fourth portion may be aligned (e.g., in a Z-direction) between a top of said first electrical connector and a bottom of said first electrical connector (and may be laterally offset from the first electrical connector). The plane is disposed substantially parallel to a base wall of the first housing member. A second plane may be aligned with a top of said first electrical connector. The fuse assembly may be disposed substantially below the second plane and above a base wall of the first housing member. The first housing member may include an L-shaped protrusion configured to retain the pre-fuse bus bar.

In embodiments, an electrical assembly may include an electrical unit including a first housing member having a substantially horizontal base wall and a plurality of side walls extending from the base wall; a second housing member; and/or a fuse assembly including a pre-fuse bus bar and at least one fuse connected to the pre-fuse bus bar. The electrical assembly may include a first electrical connector and a second electrical connector. A plane may extend through the pre-fuse bus bar, the first electrical connector, the second electrical connector, and/or the plurality of side walls. The first electrical connector and the second electrical connector may each include at least 20 terminals.

In embodiments, an electrical unit may include a first housing member, a second housing member, and a bus bar disposed at least partially in and/or connected to the first housing member. The first housing member and the second housing member may provide a chamber to receive an electrical connector. The first housing member may be configured such that, in an assembled configuration, the bus bar may be disposed at least partially between a wall of the first housing member and said electrical connector. The electrical unit may include a fuse assembly. The fuse assembly may include the bus bar and a plurality of fuses connected to the bus bar. The first housing member may be configured such that, in the assembled configuration, the fuse assembly may be disposed at least partially between a bottom of said electrical connector and the wall of the first housing member. The wall may be a base/bottom wall connected to a plurality of side walls of the first housing member. The first housing member may be configured such that, in the assembled configuration, the bus bar may be disposed at least partially between the wall and a plane aligned with a top of said electrical connector. The bus bar may be disposed at least partially between (and may be disposed substantially between) the wall and a bottom of said electrical connector. A plane may extend through the bus bar, said electrical connector, and the wall. The plane may be substantially perpendicular to the wall.

With embodiments, a second housing member may include a top portion and a bottom portion. A circuit board assembly may be disposed at least partially between the top portion and the bottom portion. A circuit board assembly may be disposed in the second housing member and may be electrically connected to the bus bar. The circuit board assembly may include a circuit board disposed substantially parallel to the wall. The circuit board assembly may include a plurality of electrical terminals connected to the circuit board. The plurality of electrical terminals may be configured for insertion into said electrical connector. Said electrical connector may include a plurality of terminals. The plurality of terminals may include at least 20 terminals. The wall may be a side wall of a plurality of side walls of the first housing member. The first housing member may include a base wall connected to each of the plurality of side walls. A majority of the bus bar may be disposed between one or more lateral sides of the electrical connector and the plurality of side walls of the first housing member. The first housing member may be configured to be mounted to a vehicle. A cover may be connected to the second housing member. A plurality of fuses may be connected to the second housing member. The plurality of fuses may be disposed at least partially between the second housing member and the cover. A bus bar may include a first portion, a second portion, a third portion, and/or a fourth portion. The first portion may be substantially perpendicular to the second portion. The third portion may be substantially perpendicular to the fourth portion. The third portion and the fourth portion may be substantially perpendicular to the first portion. The third portion and/or the fourth portion may be in contact with an inner surface of the first housing member.

In embodiments, an electrical assembly may include an electrical unit. The electrical unit may include a first housing member, a second housing member connected to the first housing member, and/or a fuse assembly connected to the first housing member. The electrical assembly may include an electrical connector configured for connection with a wiring harness. The electrical connector may be disposed entirely within the electrical unit. The fuse assembly may be disposed at least partially between the electrical connector and a wall of the first housing member. The wall may be a side wall of a plurality of side walls of the first housing member. The first housing member may include a base wall connected to each of the plurality of side walls. A plane may extend through at least portions of the electrical connector, the fuse assembly, and/or each of the plurality of side walls.

With embodiments, a method of assembling an electrical assembly may include providing a first housing member; providing a second housing member including a circuit board and a plurality of electrical terminals connected to the circuit board; connecting a fuse assembly to the first housing member; disposing an electrical connector of a wiring harness at least partially in the first housing member such that at least some of the fuse assembly is disposed between the electrical connector and a wall of the first housing member; and/or connecting the first housing member with the second housing member. Connecting the first housing member with the second housing member may include inserting the plurality of electrical terminals into the electrical connector. The wall may be a base wall. The first housing member may include a plurality of side walls. The base wall may be connected to each of the plurality of side walls.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is an exploded perspective view generally illustrating an embodiment of an electrical assembly according to teachings of the present disclosure.

FIG. 2 is an exploded perspective view generally illustrating an embodiment of an electrical assembly according to teachings of the present disclosure.

FIG. 3 is a perspective view generally illustrating an embodiment of an electrical unit according to teachings of the present disclosure.

FIGS. 4-7 are perspective views generally illustrating embodiments of electrical units, including fuse assemblies, according to teachings of the present disclosure.

FIG. 8 is a perspective view generally illustrating embodiments of an electrical unit and electrical connectors according to teachings of the present disclosure.

FIG. 9 is a perspective view generally illustrating embodiments of portions of an electrical unit and electrical connectors according to teachings of the present disclosure.

FIG. 10 is a perspective view generally illustrating embodiments of an electrical unit, including a first housing member and a second housing member, and electrical connectors, according to teachings of the present disclosure.

FIG. 11 is a perspective view generally illustrating embodiments of an electrical assembly, including a first housing member, a second housing member, and electrical connectors, according to teachings of the present disclosure.

FIG. 12 is a perspective view generally illustrating an embodiment of a first housing member of portions of an electrical unit according to teachings of the present disclosure.

FIG. 13 is an exploded view generally illustrating an embodiment of an electrical assembly according to teachings of the present disclosure.

FIG. 14 is a cross-sectional view generally illustrating portions of an embodiment of an electrical assembly according to teachings of the present disclosure.

FIG. 15 is a perspective view generally illustrating portions of an embodiment of an electrical assembly according to teachings of the present disclosure.

FIG. 16 is a cross-sectional view generally illustrating portions of an embodiment of an electrical assembly according to teachings of the present disclosure.

FIG. 17 is a perspective view generally illustrating an embodiment of a pre-fuse bus bar according to teachings of the present disclosure.

FIG. 18 is a cross-sectional view generally illustrating an embodiment of an electrical assembly including a pre-fuse bus bar according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they are not intended to limit the present disclosure to these embodiments and/or examples. On the contrary, the present disclosure is intended to cover alternatives, modifications, and equivalents.

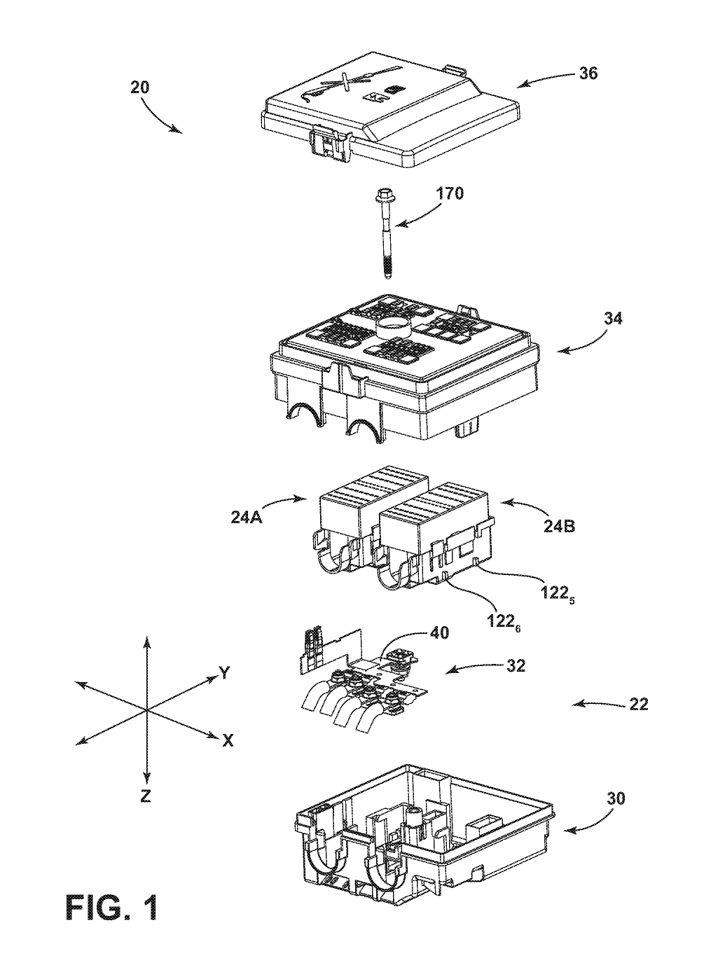

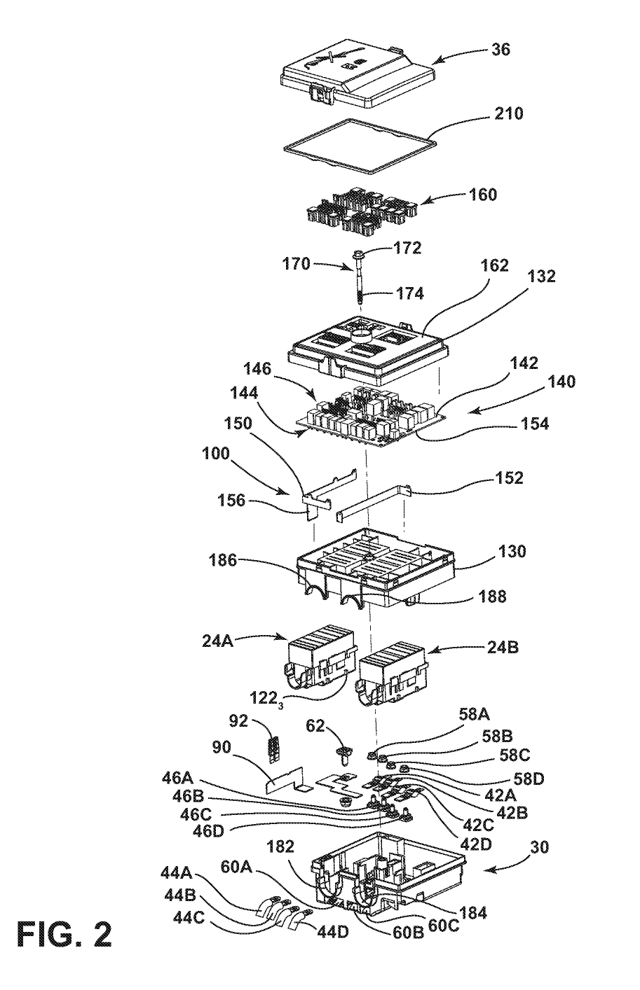

In embodiments, such as generally illustrated in FIGS. 1 and 2, an electrical assembly 20 may include an electrical unit 22 and/or one or more electrical connectors (e.g., electrical connectors 24A, 24B). An electrical unit 22 may include a first housing member 30 (e.g., a connector housing portion), a fuse assembly 32, a second housing member 34 (e.g., a fuse housing portion), and/or a cover 36. A first housing member 30 may be configured for connection with a second housing member 34 and/or may be configured to be mounted to a vehicle. A cover 36 may be configured for connection with the second housing member 34.

With embodiments, a first housing member 30 may be configured to house a fuse assembly 32 and/or one or more connectors 24A, 24B, such as wiring harness connectors. A fuse assembly 32 may be configured as a pre-fuse assembly, may be referred to herein as a pre-fuse assembly, and/or may be configured to limit current from a power source (e.g., a vehicle battery), but is not limited to a pre-fuse assembly. A fuse assembly 32 may include, for example and without limitation, a fuse or pre-fuse bus bar 40 and/or a plurality of fuses (e.g., fuses 42A, 42B, 42C, 42D) that may be connected, electrically and/or physically, to the pre-fuse bus bar 40. The fuses 42A, 42B, 42C, 42D may be configured for connection with one or more corresponding cables/wires 44A, 44B, 44C, 44D that may be connected, for example and without limitation, to vehicle components, such as a pump and/or a motor. The cables 44A, 44B, 44C, 44D may be connected to fuses 42A, 42B, 42C, 42D, such as via studs 46A, 46B, 46C, 46D that may be connected to the first housing member 30 and/or that may extend through respective apertures 48A, 48B, 48C, 48D in the fuses 42A, 42B, 42C, 42D and apertures 50A, 50B, 50C, 50D in the cables 44A, 44B, 44C, 44D. The studs 46A, 46B, 46C, 46D may, for example and without limitation, be configured to slide into corresponding slots 52A, 52B, 52C, 52D of the first housing member 30 and/or may be connected via a snap fit to the first housing member 30 with one or more snap members 54A, 54B, 54C, 54D. The slots 52A, 52B, 52C, 52D may be disposed in a base/bottom wall 56 of first housing member 30. One or more nuts 58A, 58B, 58C, 58D may be screwed onto the studs 46A, 46B, 46C, 46D, such as to fasten the cables 44A, 44B, 44C, 44D with the fuses 42A, 42B, 42C, 42D and/or to connect the fuse assembly 32 with the first housing member 30. In embodiments, the fuses 42A, 42B, 42C, 42D may be configured as high current fuses and may, for example and without limitation, include current capacities of at least 50 amps, such as about 80 amps and/or about 125 amps (or more or fewer amps). The current capacities of the fuses 42A, 42B, 42C, 42D may or may not be the same. The first housing member 30 may include one or more apertures (e.g., apertures 60A, 60B, 60C) that may be configured to receive the cables 44A, 44B, 44C, 44D. For example and without limitation, a first side wall 96A of the first housing member 30 may include apertures 60A, 60B, 60C. The first side wall 96A may be connected to and/or disposed substantially perpendicularly to the base/bottom wall 56. A second side wall 96B, a third side wall 96C, and/or a fourth side wall 96D may extend from and/or be connected to the base/bottom wall 56.

In embodiments, a fuse assembly 32 may include a power post 62 that may extend through an aperture 64 in the pre-fuse bus bar 40 and/or a corresponding aperture 66 in the first housing member 30 such that the power post 62 may extend outside of the first housing member 30 (e.g., downward). The power post 62 may, for example and without limitation, be configured for connection with a power source, such as a vehicle battery, and may be electrically conducting. A pre-fuse bus bar 40 may include a first portion 70 and/or a second portion 72. The first portion 70 may be disposed substantially perpendicular to the second portion 72. The first portion 70 and the second portion 72 may be disposed substantially in a common plane (e.g., a horizontal or X-Y plane). The first portion 70 may be connected with fuses 42A, 42B, 42C that may extend generally perpendicularly to the first portion 70, may extend generally in parallel with the second portion 72, and/or may extend generally parallel to a horizontal or X-Y plane. The aperture 66 may be disposed at or about an end 74 of the second portion 72. The first housing member 30 may include one or more latch members 80A, 80B, 80C that may be configured to retain the second portion 72, at least in one direction (e.g., a vertical or Z direction). The latch member(s) 80A, 80B, 80C may extend from the base/bottom wall 56 and/or may hold/retain the pre-fuse bus bar 40 in contact with the base/bottom wall 56. The base/bottom wall 56 may be substantially planar, may be substantially parallel with a horizontal or X-Y plane, and/or may include one or more stepped or angled portions.

With embodiments, such as generally illustrated in FIG. 4, a pre-fuse bus bar 40 may include a third portion 90 that may extend perpendicularly to the first portion 70 and/or the second portion 72 (e.g., may extend substantially vertically in a Z-direction and/or toward second housing member 34). One or more electrical terminals 92 may be connected (e.g., fixed) to the third portion 90. The first housing member 30 may include one or more recesses or apertures 94A, 94B that may be configured to receive the one or more electrical terminals 92. The recesses or apertures 94A, 94B may, for example, extend substantially vertically in the Z-direction (e.g., vertically). An electrical terminal 92 may be configured for connection with a bus bar of the second housing member 34, such as, for example and without limitation, a circuit board bus bar 100 (e.g., to provide electrical power to the second housing member 34).

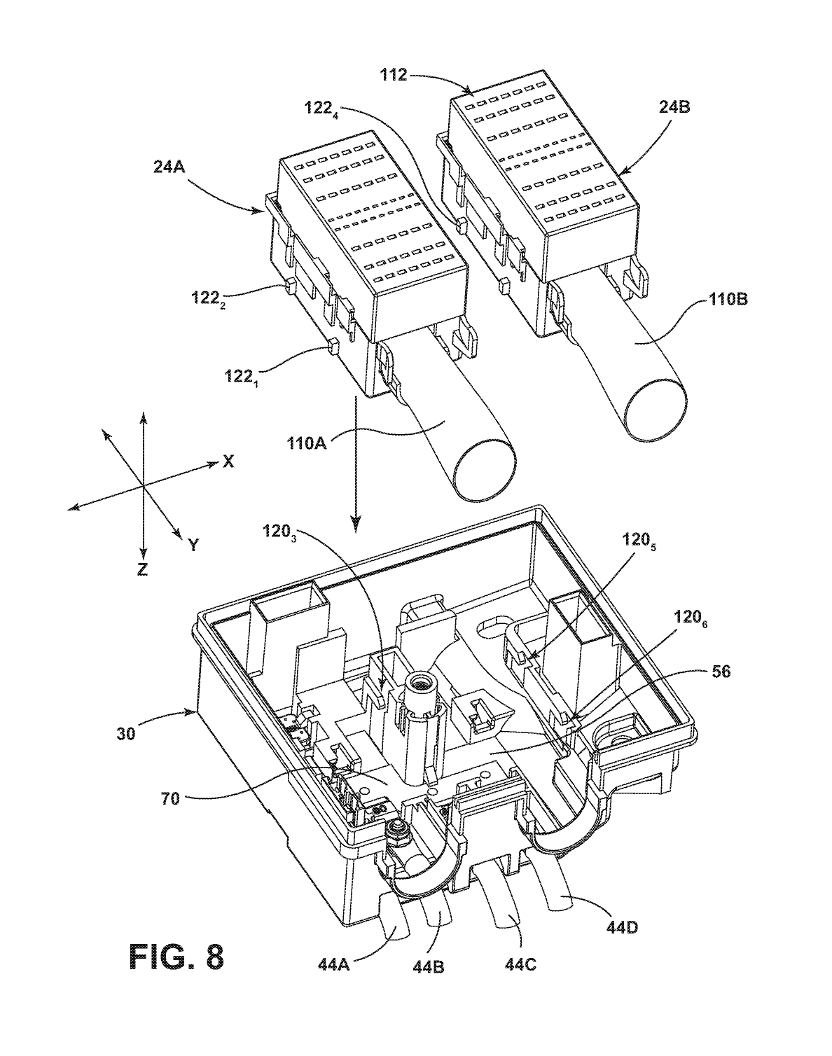

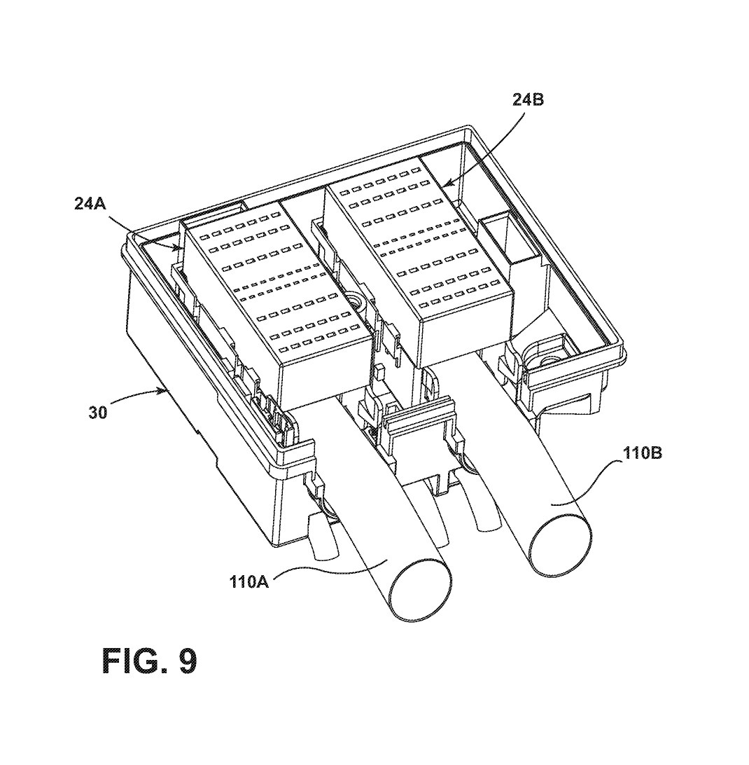

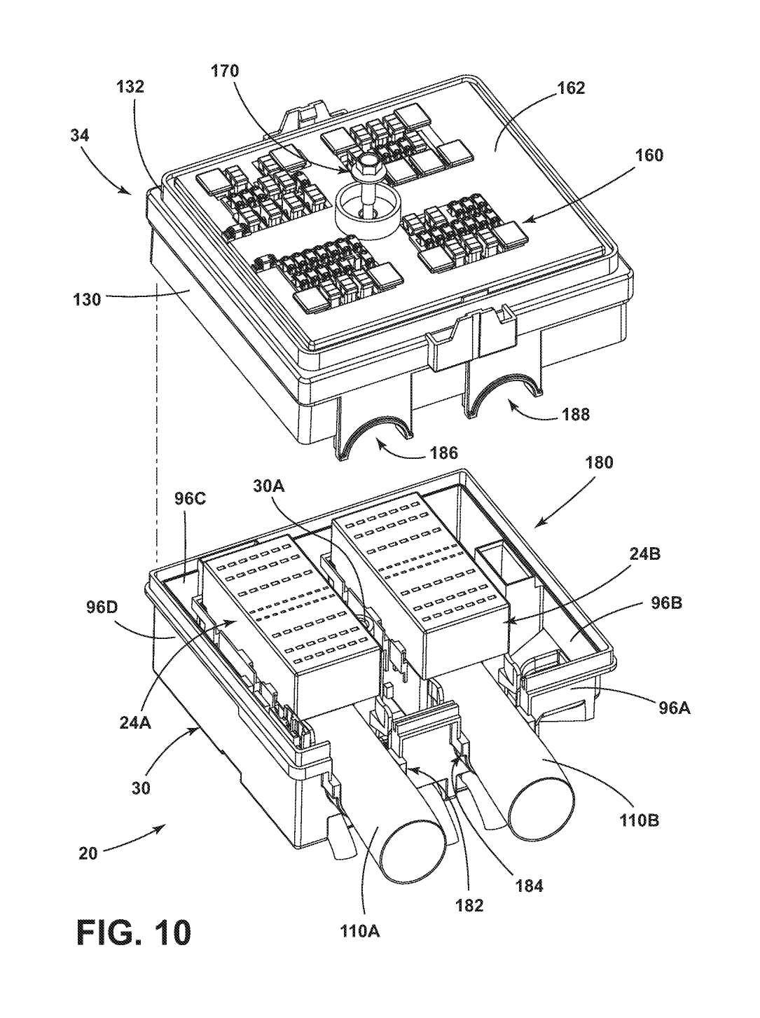

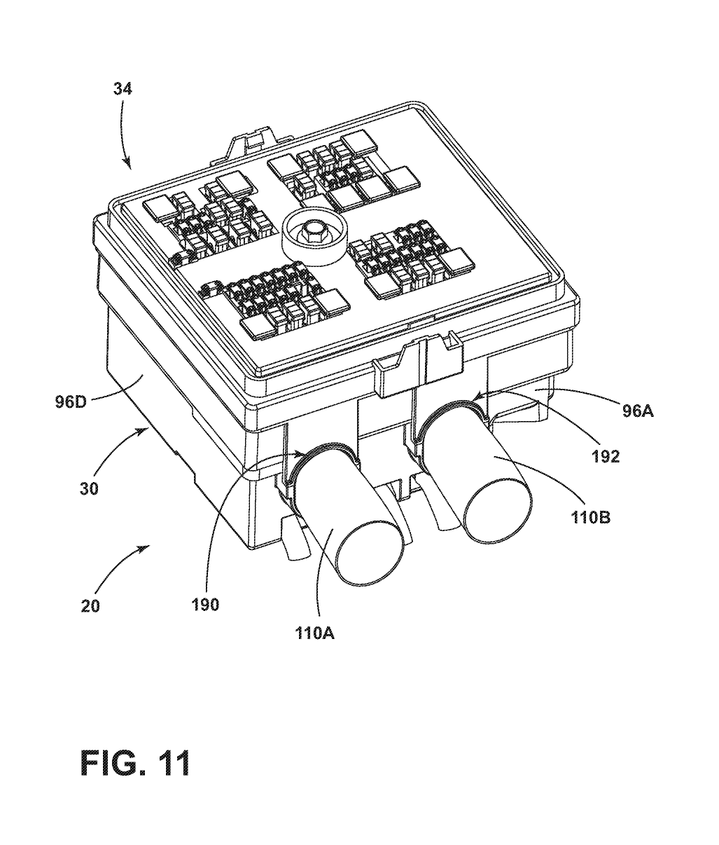

In embodiments, such as generally illustrated in FIGS. 8 and 9, a first housing member 30 may be configured to partially or entirely receive one or more connectors 24A, 24B. A connector 24A, 24B may be connected to and/or configured for connection with a wiring harness cable 110A, 110B. A connector 24A, 24B may, for example and without limitation, include a plurality of terminals/apertures 112 that may be disposed in a plurality of rows and/or a plurality of columns. For example and without limitation, a connector 24A, 24B may include at least about 20 terminals/apertures 112, at least about 50 terminals/apertures 112 (e.g., about 58 apertures), and/or more or fewer terminals/apertures 112. A first housing member 30 may include one or more retaining features 120_{N} that may be configured to retain a connector 24A, 24B relative to the first housing member 30 in at least one direction, such as the Z-direction (e.g., a vertical direction). The retaining features 120_{N} may be configured to engage corresponding connector features 122_{N} (e.g., recesses, protrusions, etc.) of the connectors 24A, 24B. For example and without limitation, the first housing member 30 may include a first set of retaining features 120₁, 120₂, 120₃ that may be configured to engage connector features 122₁, 122₂, 122₃ of a first connector 24A, and/or the first housing member 30 may include a second set of retaining features 120₄, 120₅, 120₆ that may be configured to engage connector features 122₄, 122₅, 122₆ of a second connector 24B. If first connector 24A and/or second connector 24B are inserted into first housing member 30 in a Z-direction (e.g., substantially vertically downward), retaining features 120_{N} may receive respective the connector features 122_{N} of the connectors 24A, 24B. The connectors 24A, 24B may then be moved in a Y-direction (e.g., horizontally) to a position in which the retaining features 120_{N} may restrict and/or prevent movement of the connectors 24A, 24B in the Z-direction. The retaining features 120_{N} may be configured to retain the first connector 24A and/or the second connector 24B such that the terminals/apertures 112 may open away from the fuse assembly 32 and/or the base/bottom wall 56 (e.g., the terminals/apertures 112 open toward second housing member 34). In a connected/assembled configuration (see, e.g., FIGS. 10 and 11), at least a portion (e.g., a bottom half) of first connector 24A and/or second connector 24B may be disposed in first housing member 30.

With embodiments, such as generally illustrated in FIGS. 1, 2, 10, and 11, a second housing member 34 may include a first/bottom portion 130 and a second/top portion 132. The first portion 130 and the second portion 132 may be connected together. The first portion 130 and/or the second portion 132 may be configured to house a circuit board assembly 140. The first portion 130 may be configured to receive at least a portion of one or more connectors 24A, 24B, such as from a bottom of the bottom portion 130. A circuit board assembly 140 may include a circuit board 142, a circuit board bus bar 100, electrical terminals 144, and/or electrical components 146 (e.g., relays, switches, fuses, resistors, capacitors, power supplies, controllers, processors, etc.). A circuit board bus bar 100 may include a first section 150 and a second section 152 that may or may not be separate from each other. The circuit board bus bar 100 may be connected (e.g., directly, such as via soldering and/or one or more electrical terminals) to a first/bottom side 154 of the circuit board 142. A first section 150 of the circuit board bus bar 100 may be connected to the circuit board 142 and/or may be connected to (e.g., inserted into) an electrical terminal 92 of the pre-fuse bus bar 40. For example and without limitation, the first section 150 may include an extension 156 that may extend in a Z-direction (e.g., vertically downward) through the first portion 130 of the second housing member 34 into the electrical terminal or terminals 92, which may include extending into the recesses or apertures 94A, 94B of the first housing member 30.

In embodiments, a second/top portion 152 of second housing member 34 may be configured to at least partially receive one or more fuses 160. For example and without limitation, a plurality of fuses 160 may be inserted into a top side 162 of second portion 152 and may extend through top side 162 to connect with circuit board assembly 140.

With continued reference to FIGS. 1, 2, 10, and 11, in embodiments, an electrical unit 22 may include one or more fasteners (e.g., fastener 170), such as a bolt. The one or more fasteners 170 may be configured to connect the second housing member 34 with the first housing member 30 and/or with one or more electrical connectors 24A, 24B. For example and without limitation, a head 172 of a fastener 170 may be disposed at a top side 162 of the second portion 132 of the second housing member 34, and a body 174 of the fastener 170A may extend into or through the second portion 132, the circuit board 142, and/or the first portion 130, and may extend into (e.g., be screwed into) an aperture 30A of the first housing member 30. Additionally or alternatively, a fastener 170 may be screwed into a connector 24A, 24B. An electrical unit 22 may include a plurality of fasteners 170 that may, for example and without limitation, be screwed into respective apertures 30A of the first housing member 30 and/or into the electrical connectors 24A, 24B.

In embodiments, a first housing member 30 and a second housing member 34 may cooperate to provide an internal chamber 180 (see, e.g., FIG. 10). The internal chamber 180 may be configured to partially or entirely receive one or more connectors, such as a first connector 24A and/or a second connector 24B. With embodiments, the first housing member 30 and the second housing member 34 may cooperate to provide one or more apertures through which a wires or cables (e.g., wiring harness cables 110A, 110B) may extend. For example and without limitation, the first housing member 30 may include a first recess 182 and a second recess 184 that may, in an assembled configuration, align with a first recess 186 and a second recess 188, respectively, of second housing member 34 to provide a first aperture 190 and a second aperture 192 (see, e.g., FIG. 11), respectively. The first aperture 190 may be configured such that the first connector 24A may not fit through the first aperture 190. The second aperture 192 may be configured such that the second connector 24B may not fit through the second aperture 192 (e.g., the first and second apertures 190, 192 may be smaller, in at least one dimension, than first and second connectors 24A, 24B). In embodiments, in an assembled configuration, at least some of a fuse assembly 32 (e.g., at least some of the pre-fuse bus bar 40) may be disposed between a base/bottom wall 56 of the first housing member 30 and the first connector 24A and/or may be disposed between base/bottom wall 56 and the second connector 24B. With embodiments, the fuse assembly 32 may be the only thing disposed between the first connector 24A and the first housing member 30 and/or between the second connector 24B and second housing member 34 (e.g., in a Z-direction or vertical direction). In embodiments, the aperture 190 may be disposed at least partially above the aperture 60A, and/or the aperture 192 may be disposed at least partially above the aperture 60C. Some or all of the apertures 60A, 60B, 60C, 190, 192 may be separate/independent from each other.

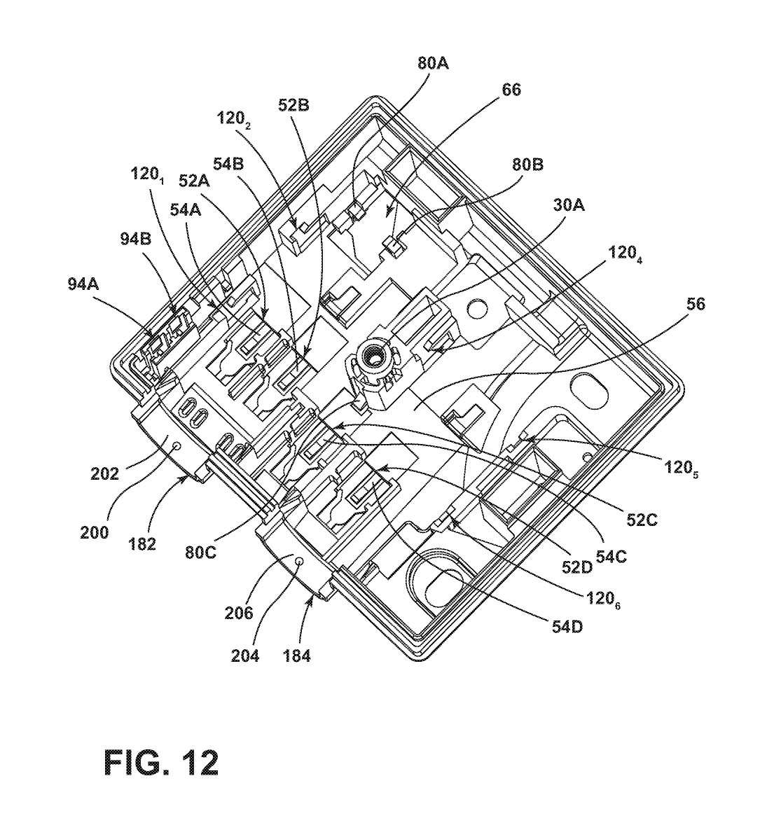

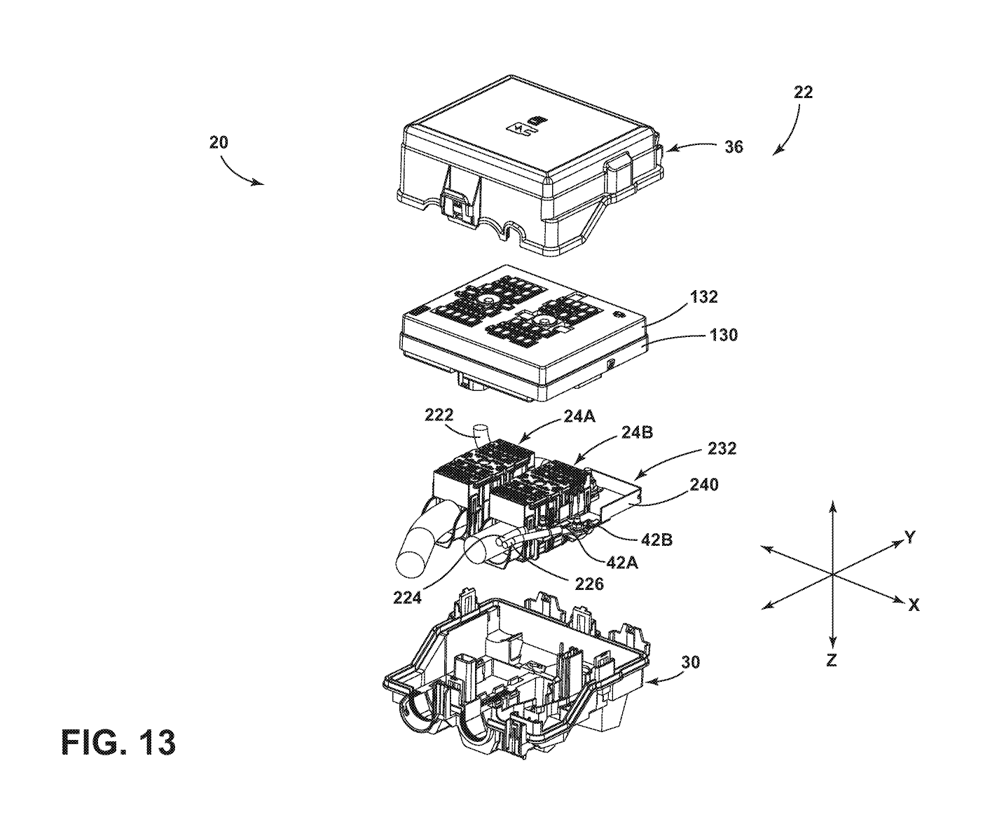

In embodiments, such as generally illustrated in FIG. 12, an electrical unit 22 may include one or more drain ports through which fluid (e.g., water) may be permitted to exit an electrical unit 22. For example and without limitation, a first drain port 200 may be disposed in a bottom surface 202 of the first recess 182 of the first housing member 30 and a second drain port 204 may be disposed in a bottom surface 206 of the second recess 184 of the first housing member 30.

With embodiments, an electrical unit 22 may include a cover 36 that may be configured to at least partially cover second portion 132 of second housing member 34 and/or some or all of fuses 160 that may be connected to second portion 132 (see, e.g., FIGS. 1 and 2). For example and without limitation, a plurality of fuses 160 may be disposed at least partially between the second/top portion 132 of the second housing member 34 and the cover 36. A sealing member 210 may be disposed between cover 36 and second portion 132 to provide a fluid seal between cover 36 and second portion 132 (see, e.g., FIG. 2).

With embodiments, an electrical unit 22 may not include any external connectors or slots for directly connecting with corresponding connectors (e.g., all electrical connections may be made entirely within electrical unit 22). In embodiments, an electrical unit 22 may be configured as a power distribution box with an integrated pre-fuse assembly 32 and a top down configuration.

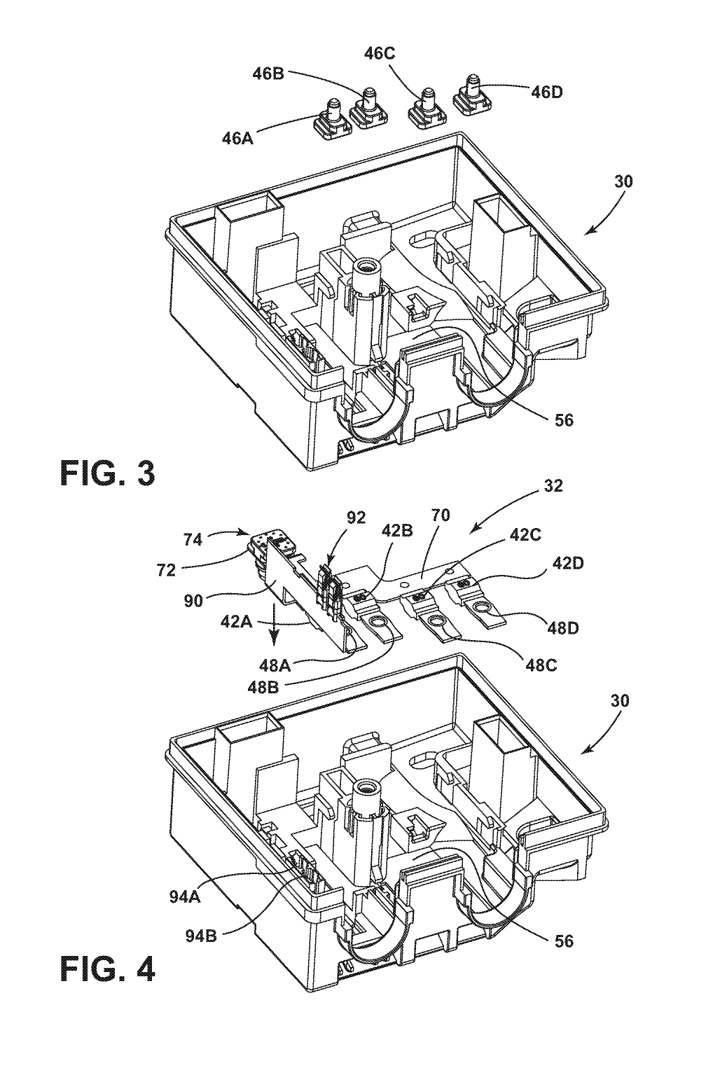

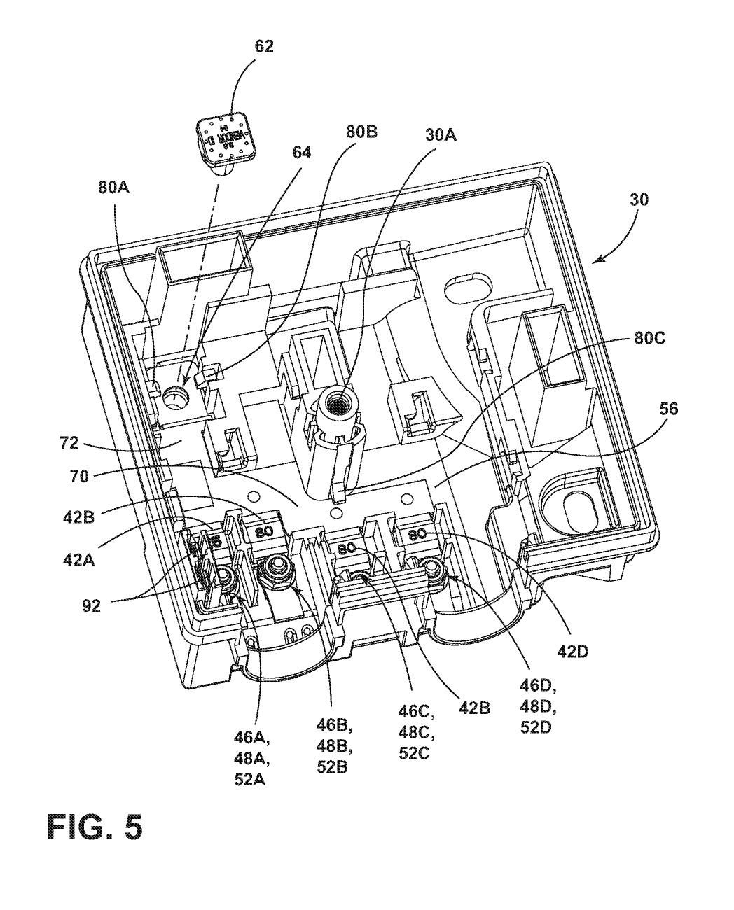

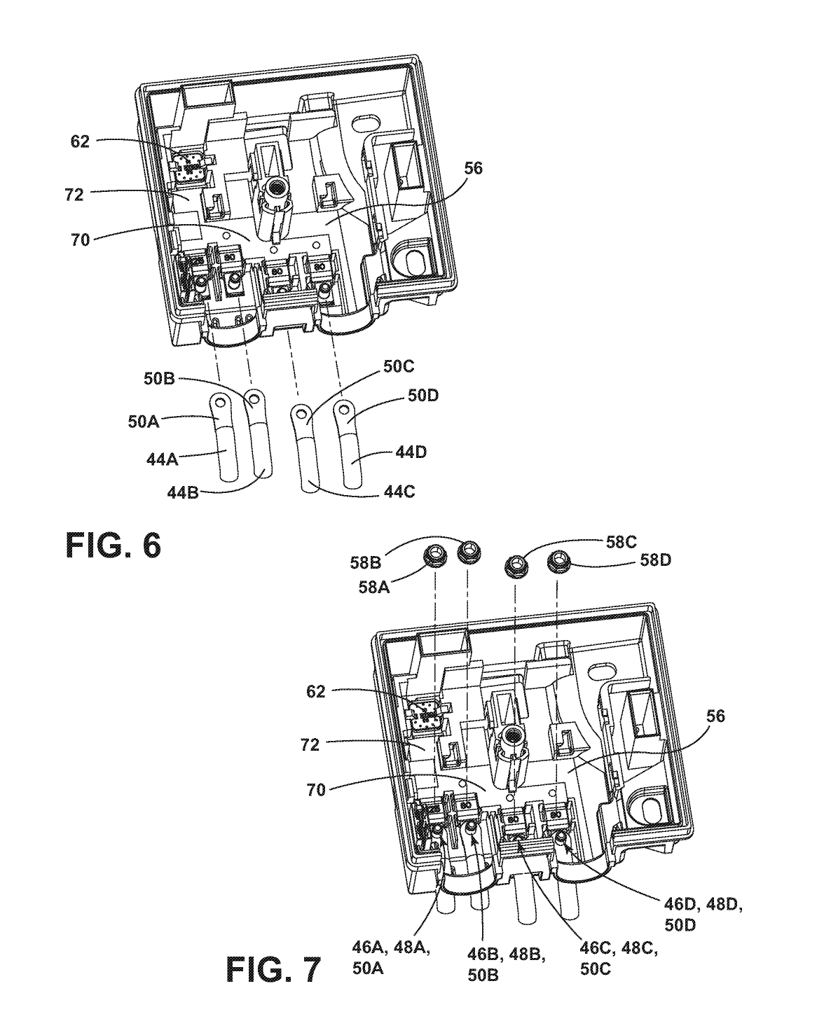

In embodiments, such as generally illustrated in FIGS. 3-12, a method of assembling an electrical assembly 20 may include providing one or more portions of an electrical unit 22, which may include providing a first housing member 30, providing a second housing member 34, and/or providing a fuse assembly 32. A second housing member 34 may include a circuit board assembly 140 that may include a circuit board 142 and/or a plurality of electrical terminals 144 connected to circuit board 142. The method may include connecting a fuse assembly 32 to the first housing member 30 (see, e.g., FIGS. 3-5). Connecting a fuse assembly 32 to the first housing member 30 may include sliding one or more studs 46A, 46B, 46C, 46D into slots 52A, 52B, 52C, 52D of the first housing member 30 such that the one or more studs 46A, 46B, 46C, 46D snap into place. The fuses 42A, 42B, 42C, 42D, which may be fixed to a pre-fuse bus bar 40, may be disposed over the studs 46A, 46B, 46C, 46D such that the studs 46A, 46B, 46C, 46D are inserted into the apertures 48A, 48B, 48C, 48D of the fuses 42A, 42B, 42C, 42D. Connecting a fuse assembly 32 to the first housing member 30 may include connecting a second portion 72 of the pre-fuse bus bar 40 to the first housing member 30 via a snap connection, such as via a pair of opposing latch members 80A, 80B, and/or may include connecting a first portion 70 of the pre-fuse bus bar 40 to the first housing member 30 via a snap connection, such as via a latch member 80C.

With embodiments, a method of assembling an electrical assembly 20 may include disposing at least one electrical connector 24A, 24B of a wiring harness such that at least some of the fuse assembly 32 is disposed between the at least one electrical connector 24A, 24B and a base/bottom wall 56 of the first housing member 30. The method may include connecting the first housing member 30 with the second housing member 34. The first housing member 30 and the second housing member 34 may be connected such that the at least one electrical connector 24A, 24B is disposed at least partially between (e.g., in a Z-direction) the fuse assembly 32 and the second housing member 34 (e.g., in an internal chamber 180).

With embodiments, connecting the first housing member 30 with the second housing member 34 may include inserting a plurality of electrical terminals 144 of the circuit board assembly 140 into the at least one electrical connector 24A, 24B. The second housing member 34 may include a circuit board bus bar 100. Connecting the first housing member 30 with second housing member 34 may include inserting a portion (e.g., extension 156) of the circuit board bus bar 100 into an electrical terminal 92 connected to a pre-fuse bus bar 40. One or more fasteners 170 may be inserted into and/or through the second housing member 34 and screwed into the first housing member 30 (e.g., into an aperture 30A of the first housing member 30) and/or into the electrical connector 24A and/or 24B. A cover 36 may be connected to second housing member 34.

In embodiments, such as generally shown in FIGS. 13, 14, and 15, an electrical assembly 20 may include an electrical unit 22, a first electrical connector 24A, and/or a second electrical connector 24B. An electrical assembly 20 may include a fuse assembly 232 (e.g., instead of or in addition to the fuse assembly 32). The fuse assembly 232 (e.g., a pre-fuse assembly) may include a pre-fuse bus bar 240 that may be disposed substantially to the side of the first electrical connector 24A and/or the second electrical connector 24B (e.g., instead of the pre-fuse bus bar 40 being disposed substantially below the first electrical connector 24A and/or the second electrical connector 24B). The pre-fuse bus bar 240 may be laterally offset from the first electrical connector 24A and/or the second electrical connector 24B. The pre-fuse bus bar 240 may be disposed to a side of the first housing member 30. For example and without limitation, the pre-fuse bus bar 40 may be offset from a middle of the first housing member 30, and/or the pre-fuse bus bar 40 may be disposed closer to a side of the first housing member 30 than to the middle of the first housing member 30.

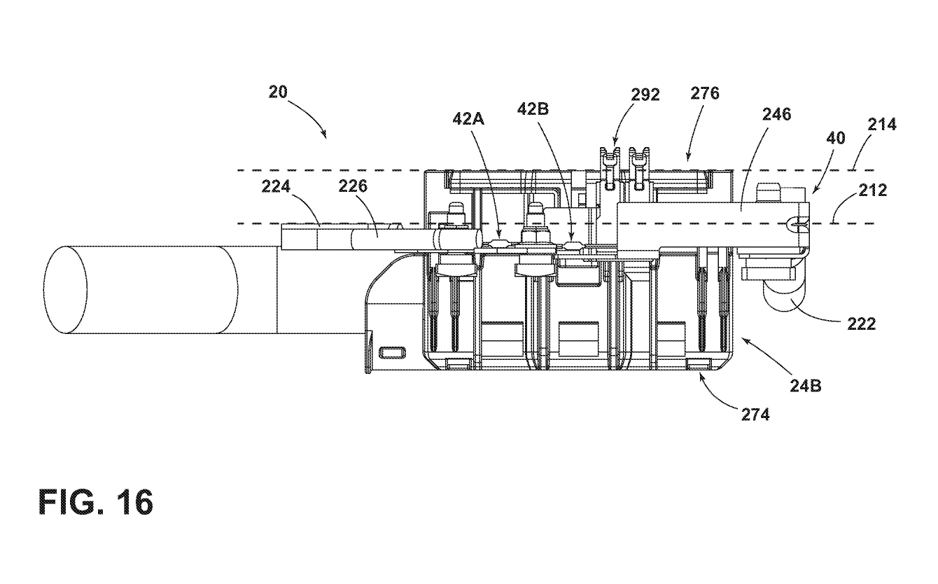

In embodiments, such as generally illustrated in FIG. 16, a plane 212 may extend through portions of the pre-fuse bus bar 40, the first electrical connector 24A, the second electrical connector 24B, and/or the fuse assembly 232 (e.g., through at least one fuse 42A, 42B, 42C and/or the pre-fuse bus bar 240). The plane 212 may be an X-Y plane, may be substantially horizontal, and/or may be substantially parallel to a circuit board 142 and/or a base/bottom wall 56 of the first housing member 30. The plane 212 may be substantially perpendicular to the first wall 96A, the second wall, 96B, the third wall, 96C, and/or the fourth wall 96D. The first electrical connector 24A may be disposed substantially between (e.g., in an X-direction and/or Y-direction) the pre-fuse bus bar 40 and the second electrical connector 24B.

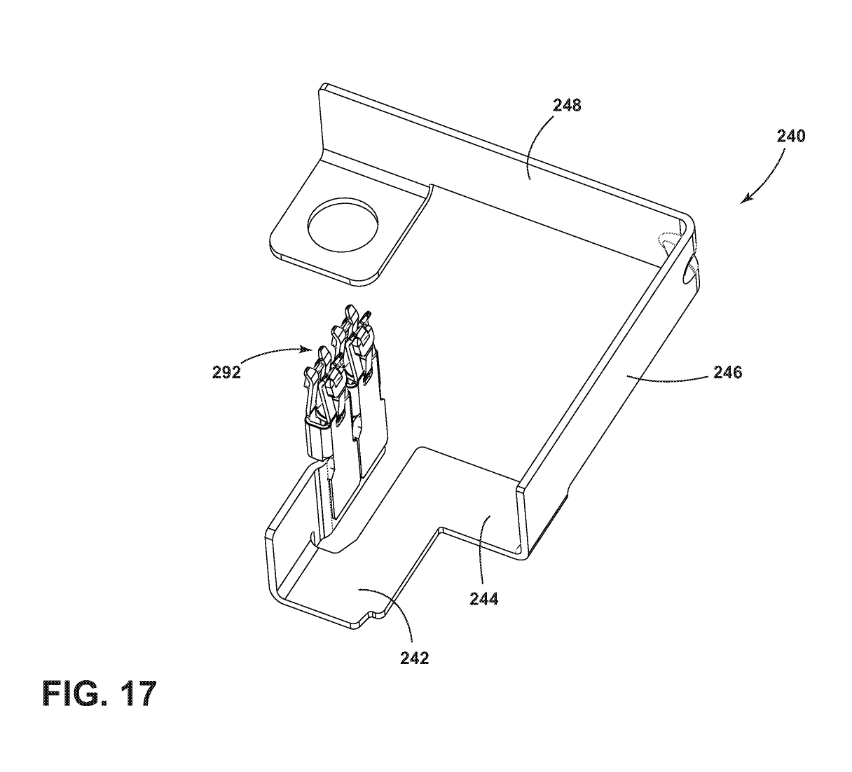

With embodiments, such as generally shown in FIG. 17, a pre-fuse bus bar 40 may include one or more of a variety of shapes, sizes, and/or configurations. For example and without limitation, the pre-fuse bus bar 40 may include a first portion 242, a second portion 244, a third portion 246, and/or a fourth portion 248. The first portion 242, the second portion 244, the third portion 246, and/or the fourth portion 248 may be substantially planar and/or generally rectangular. The first portion 242 may extend from the second portion 244, the second portion 244 may extend from the third portion 246, and/or the third portion 246 may extend from the fourth portion 248. The first portion 242 may be substantially perpendicular to the second portion 244, and/or the first portion 242 and the second portion 244 may be disposed substantially in the same plane. The third portion 246 may be substantially perpendicular to the fourth portion 248. The third portion 246 and the fourth portion 248 may be perpendicular to the first portion 242 and the second portion 244. For example and without limitation, the first portion 242 and the second portion 244 may be substantially parallel to the plane 212, which may be substantially perpendicular to the third portion 246 and/or the fourth portion 248. The plane 212 may extend through and/or intersect with a majority of the pre-fuse bus bar 40. For example and without limitation, the plane 212 may extend through all or substantially all of the length of the third portion 246 and/or the length of the fourth portion 248. The first portion 242 and the second portion 244 may be disposed between the plane 212 and a base/bottom wall 56 of the first housing member 30. The plane 212 may extend through the pre-fuse bus bar 240, one or more electrical connectors 24A, 24B, and/or some or all of the walls 96A, 96B, 96C, 96D.

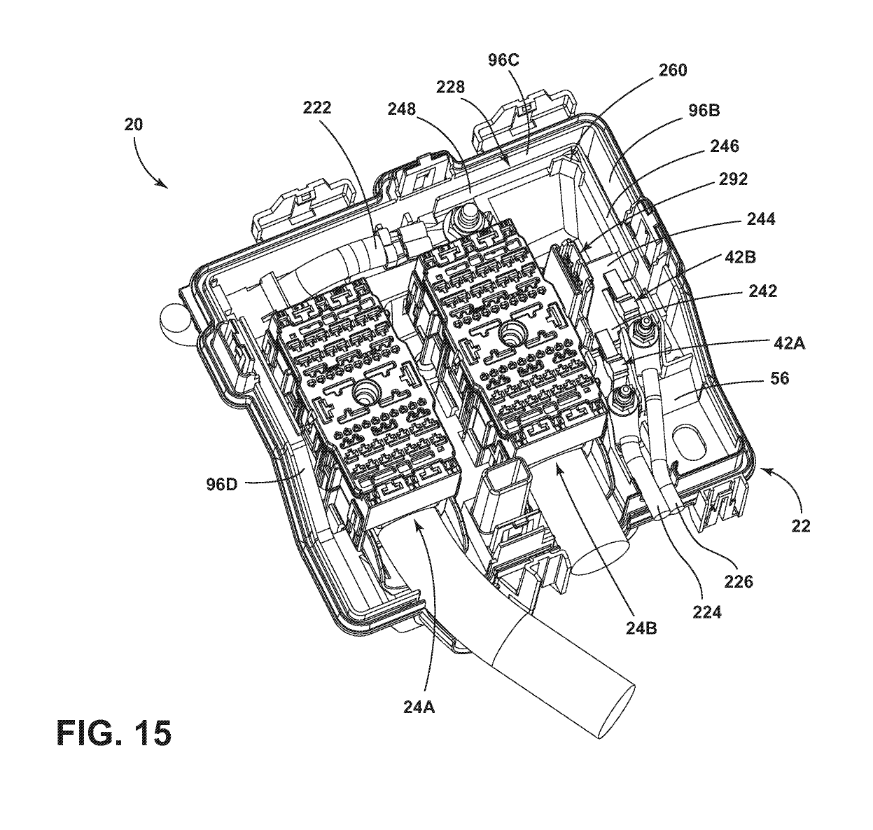

With embodiments, the pre-fuse bus bar 40 may be connected to a first wire 222, a second wire 224, and/or a third wire 226 (see, e.g. FIG. 15). The first wire 222 may be connected to the fourth portion 248 of the pre-fuse bus bar 40, the second wire 224 may be connected to the first portion 242 of the pre-fuse bus bar 40, and/or the third wire 226 may be connected to the second portion 244 of the pre-fuse bus bar 40 (see, e.g. FIG. 17). The first wire 222 may include a larger current capacity than the second wire 224 and/or the third wire 226 (e.g., the first wire 222 may be a high current wire and the second wire 224 and/or third wire 226 may be low current wires).

With embodiments, the pre-fuse bus bar 40 may contact an inner surface 228 of the first housing member 30 (see, e.g., FIG. 15). The inner surface 228 may, for example and without limitation, include portions of the base/bottom wall 56, a second side wall 96B, and/or a third side wall 96C. The first portion 242, the second portion 244, the third portion 246, and/or the fourth portion 248 may contact the inner surface 228. The first portion 242 and/or the second portion 244 may contact the base/bottom wall 56 of the first housing member 30. The third portion 246 may contact the second side wall 96B of the first housing member 30, and/or the fourth portion 248 may contact the third side wall 96C of the first housing member 30. The first housing member 30 may include a protrusion 260 extending (in a Z-direction) from the inner surface 228 and/or the base/bottom wall 56.

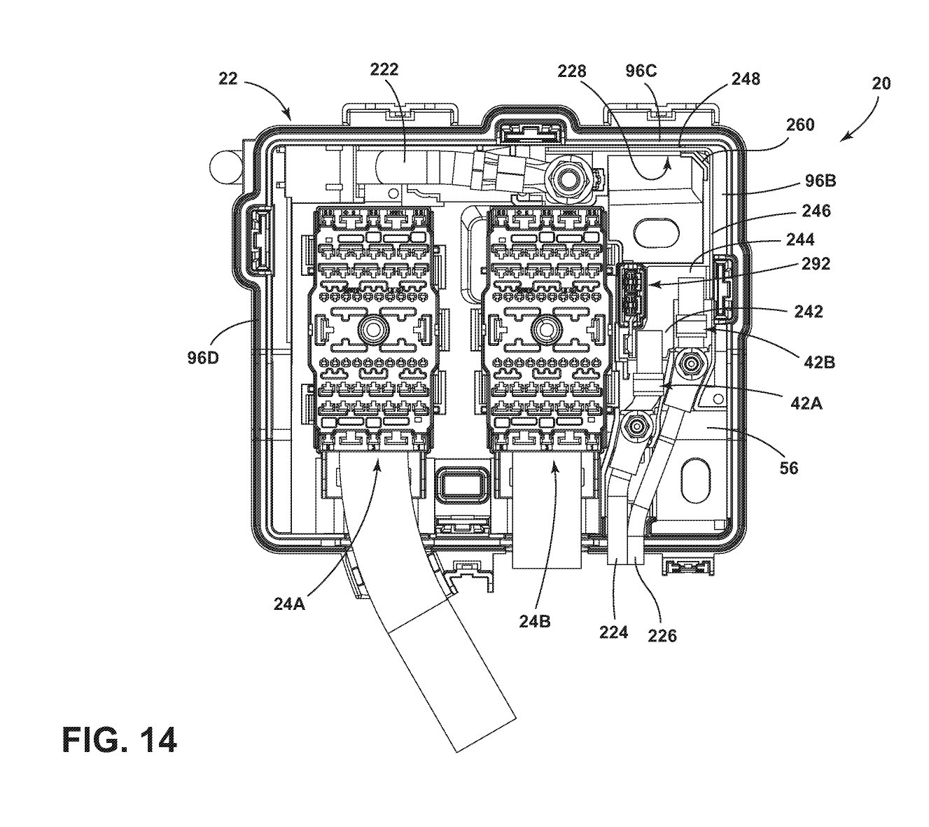

In embodiments, the protrusion 260 may include one or more of a variety of shapes, sizes, and/or configurations. For example and without limitation, the protrusion 260 may be triangular, L-shaped, substantially curved, and/or include a plurality of planar portions. The protrusion 260 may contact an inner surface of the third portion 246 and/or the fourth portion 248 of the pre-fuse bus bar 240 (see, e.g., FIGS. 14 and 15). The protrusion 260 may be configured to limit movement in at least one direction (e.g., X-directions and/or Y-direction) of the pre-fuse bus bar 40. The protrusion 260 may secure the pre-fuse bus bar 40 in a relatively fixed position within the electrical assembly 20 to maintain electrical connections. The protrusion 260 may only permit movement of the pre-fuse bus bar 40 in one direction (e.g., a Z-direction), such as to insert and/or remove the pre-fuse bus bar 40 from between the protrusion 260 and the inner surface 228 of the first housing member 30. Some or all of the third portion 246 may be disposed between the protrusion 260 and the second wall 96B, and/or some or all of the fourth portion 248 may be disposed between the protrusion 260 and the third wall 96C. The protrusion 260 may not limit vertical movement of the pre-fuse bus bar 40 relative to the first housing member 30. An electrical terminal 292 may be connected to the first portion 242 of the pre-fuse bus bar 40. The electrical terminal 292 may be disposed adjacent to and/or not in contact with the second portion 244 of the pre-fuse bus bar 40. The electrical terminal 292 may be perpendicular to the first portion 242, the second portion 244 and/or the fourth portion 248, and/or the electrical terminal 292 may be parallel to the third portion 246. The electrical terminal 292 may be configured for connection (e.g., electrical and/or mechanical/physical) with a circuit board bus bar 100.

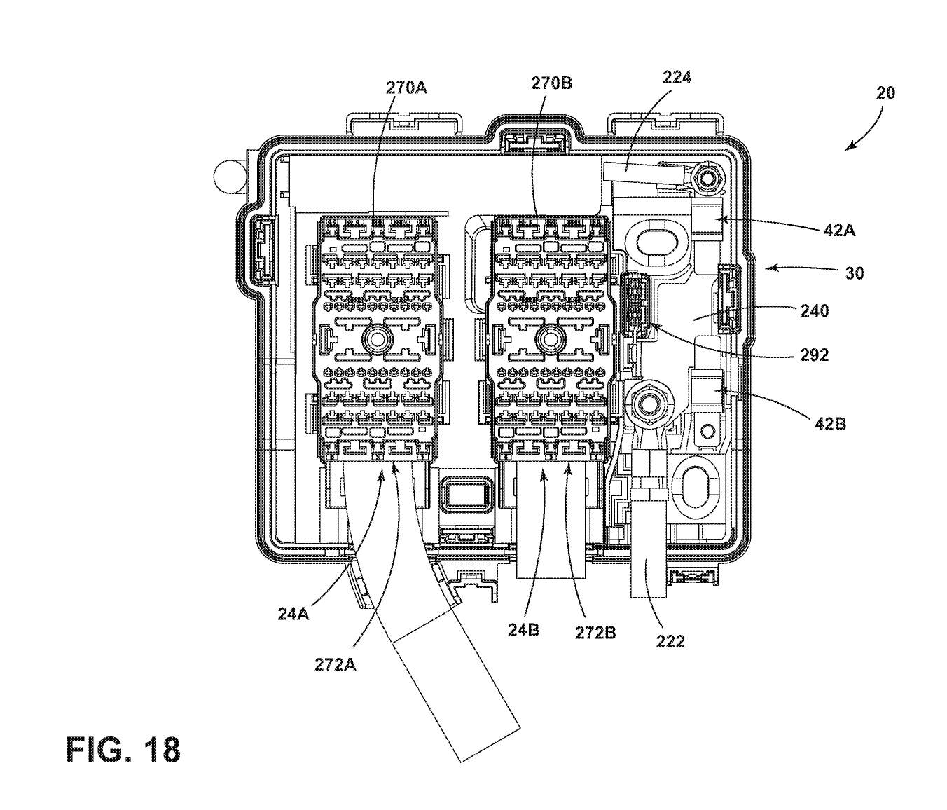

In embodiments, such as generally illustrated in FIG. 18, some or all of a pre-fuse bus bar 240 may generally be planar and parallel to an X-Y plane (e.g., a horizontal plane). The majority of the pre-fuse bus bar 240 may be substantially parallel to a first plane 212 (e.g., an X-Y plane), and/or the electric terminal 292 may be substantially parallel to a second plane (e.g., a Y-Z plane) that may be perpendicular to the first plane 212. The pre-fuse bus bar 240 may be substantially disposed between (e.g., relative to the Y-direction) a first longitudinal end 270A and a second longitudinal end 272A of the first electrical connector 24A and/or the pre-fuse bus bar 240 may be substantially disposed between a first longitudinal end 270B and a second longitudinal end 272B of the second electrical connector 24B.

With embodiments, a fuse assembly 32, 232 and/or a pre-fuse bus bar 40, 240 may be disposed at least partially between a wall (e.g., the base/bottom wall 56, the second side wall 96B, and/or the third side wall 96C) of the first housing member 30 and an electrical connector 24A, 24B, such as in an assembled or partially assembled configuration. In such embodiments, the fuse assembly 32, 232 and/or the pre-fuse bus bar 40, 240 may be disposed at least partially between a bottom 274 of an electrical connector 24A, 24B and/or may be disposed to a lateral side of an electrical connector 24A, 24B. The fuse assembly 32, 232 and/or the pre-fuse bus bar 40, 240 may be disposed substantially between the base/bottom wall 56 and a plane 214 aligned with a top 276 of an electrical connector 24A, 24B. For example and without limitation, substantially all of the fuse assembly 32, 232 and/or the pre-fuse bus bar 40, 240 may be disposed below the plane 214, and/or the electrical terminal 92, 292 may be the only portion of the pre-fuse bus bar 40, 240 disposed above the plane 214. In embodiments, a majority of a fuse assembly 232 and/or a pre-fuse bus bar 240 may, for example and without limitation, be disposed between (e.g., in an X-direction and/or a Y-direction) lateral sides of one or more connectors 24A, 24B and the plurality of side walls 96A, 96B, 96C, 96D of the first housing member 30.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

It is intended that all matter contained in the above description or shown in the accompanying drawings shall be interpreted as illustrative only and not limiting. Changes in detail or structure may be made without departing from the present disclosure.

What is claimed is:

1. An electrical unit, comprising:
a first housing member;
a second housing member; and
a fuse assembly including a pre-fuse bus bar disposed at least partially in the first housing member;
wherein the first housing member is configured to receive a first electrical connector such that a plane extends through the pre-fuse bus bar and said first electrical connector.

2. The electrical unit of claim 1, wherein the fuse assembly includes a fuse, and the plane extends through the pre-fuse bus bar, said first electrical connector, and the fuse.

3. The electrical unit of claim 1, wherein the first housing member is configured to receive a second electrical connector such that said first electrical connector is disposed between the pre-fuse bus bar and said second electrical connector.

4. The electrical unit of claim 3, wherein the first housing member is configured such that the plane extends through the pre-fuse bus bar, said first electrical connector, and said second electrical connector.

5. The electrical unit of claim 1, wherein the pre-fuse bus bar is disposed substantially to a side of the first housing member.

6. The electrical unit of claim 1, including a circuit board bus bar connected to the pre-fuse bus bar.

7. The electrical unit of claim 6, wherein the circuit board bus bar is at least partially disposed in the second housing member and is connected directly to a circuit board of the second housing member.

8. An electrical assembly including the electrical unit of claim 1, the first electrical connector, and a second electrical connector; wherein the pre-fuse bus bar is laterally offset from at least one of the first electrical connector and the second electrical connector.

9. The electrical unit of claim 8, wherein the pre-fuse bus bar is aligned substantially between a first longitudinal end of the first electrical connector and a second longitudinal end of the first electrical connector.

10. The electrical unit of claim 9, including a second electrical connector, wherein the pre-fuse bus bar is aligned substantially between a first longitudinal end of the second electrical connector and a second longitudinal end of the second electrical connector.

11. The electrical unit of claim 1, wherein said first electrical connector includes at least 10 terminals.

12. An electrical assembly including the electrical unit of claim 1, a first wire, and a second wire; wherein the first wire and the second wire are connected to the pre-fuse bus bar; and a current capacity of the first wire is greater than a current capacity of the second wire.

13. The electrical unit of claim 1, wherein the pre-fuse bus bar includes a first portion, a second portion, a third portion, and a fourth portion; the first portion is substantially perpendicular to the second portion; and the third portion is substantially perpendicular to the fourth portion.

14. The electrical unit of claim 13, wherein the third portion and the fourth portion are perpendicular to the first portion; the first portion and the second portion are substantially horizontal; the third portion and the fourth portion are substantially vertical; and the plane extends through the third portion and the fourth portion of the pre-fuse bus bar.

15. The electrical unit of claim 13, wherein the first portion, the second portion, the third portion, and the fourth portion are aligned between a top of said first electrical connector and a bottom of said first electrical connector.

16. The electrical unit of claim 1, wherein the plane is disposed substantially parallel to a base wall of the first housing member.

17. The electrical unit of claim 1, wherein a second plane is aligned with a top of said first electrical connector; and the fuse assembly is disposed substantially between the second plane and above a base wall of the first housing member.

18. The electrical unit of claim 1, wherein the first housing member includes an L-shaped protrusion configured to retain the pre-fuse bus bar.

19. An electrical assembly, comprising:
an electrical unit, including:
a first housing member including a base wall and a plurality of side walls extending from the base wall;
a second housing member; and
a fuse assembly including a pre-fuse bus bar and at least one fuse connected to the pre-fuse bus bar;
a first electrical connector; and
a second electrical connector;
wherein a plane extends through the pre-fuse bus bar, the first electrical connector, the second electrical connector, and the plurality of side walls.

20. The electrical assembly of claim 19, wherein the first electrical connector and the second electrical connector each include at least 20 terminals.
